(19) United States
(12) Patent Application Publication
(10) Pub. No.: US 2010/0079281 A1
(43) Pub. Date: Apr. 1, 2010

(54) ATTACHABLE DOCUMENT MANAGER

(75) Inventor: Eduardo E. Drake, Golden Valley, MN (US)

Correspondence Address: SCHWEGMAN, LUNDBERG & WOESSNER, P.A., P.O. BOX 2938, MINNEAPOLIS, MN, 55402, US

(73) Assignee: Eduardo E. Drake, Golden Valley, MN (US)

(21) Appl. No.: 12/433,415

(22) Filed: Apr. 30, 2009

Related U.S. Application Data
(63) Continuation of application No. 11/428,526, filed on Jul. 3, 2006, now abandoned.
(60) Provisional application No. 60/695,966, filed on Jul. 1, 2005.

(51) Int. Cl. G08B 23/00; G08B 3/10

(52) U.S. Cl. 340/540; 340/384.71

(57) ABSTRACT

A novel programmable timer includes a sensor for sensing opening of a refrigerator or cabinet door and an alarm outputting a visible and/or audible alarm when a timer has expired if and only if the sensor indicates that the door is open, thereby preventing expenditure of the alarm at times when the alarming function is likely to be ineffective. The timer is also attachable to an article of food within the refrigerator or to a wall or other portion of the refrigerator via a spring clip, magnet, and/or releasable adhesive.

### RELATED APPLICATION

The present application is a continuation of U.S. application Ser. No. 11/428,526, filed on Jul. 3, 2006, which claims the benefit of U.S. Provisional Application 60/695,966, filed on Jul. 1, 2005, which applications are incorporated herein by reference in their entirety.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2005, Eduardo E. Drake.

### TECHNICAL FIELD

Various embodiments of the present invention concern automated reminders and timers, methods, and components, particularly devices that may be clipped to or otherwise attached to an object.

### BACKGROUND

Timers of various forms provide great utility in a variety of everyday activities. For example, timers are used to signal when programmed cooking times have elapsed, when sleeping or wake times have arrived, and when to take medications. Some of these timers include spring clips and/or magnets that allow them to be attached other objects.

The present inventor recognized that many of these devices suffer from one or more problems, depending on the context of their desired use.

First, conventional timers have timing periods measured in minutes or hours. These periods are too short to accommodate the relevant time periods of some potential reminder functions that the inventor envisions. For example, none of the attachable timers that the inventor is aware of, allows setting an alarm to activate days, weeks, or even months after the initial setting.

Second, conventional timers lack the ability to shift alarm activation from an inappropriate time to a more appropriate time. For example, the inventor envisions a long-term timer having a duration of several days, where the timer may be initially activated during a normal sleeping time and thus if set to expire an integral number of days or weeks or months later would activate the alarm in the normal sleeping time, contrary to the desires of most users.

### BRIEF DESCRIPTION OF THE DRAWINGS

FIG. 1 is a block diagram of an exemplary programmable timer corresponding to one or more embodiments of the present invention.

FIG. 2 is a flow chart of an exemplary method of operating a programmable timer, which corresponds to one or more embodiments of the invention.

FIG. 3 is a block diagram of an exemplary timer kit corresponding to one or more embodiments of the present invention.

FIG. 4 is a perspective view of an exemplary clip on and/or magnetic timer which corresponds to one or more embodiments of the invention.

### DETAILED DESCRIPTION OF EXEMPLARY EMBODIMENT(S)

This description describes one or more specific embodiments of invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Note that the features of various embodiments may be combined with features of other embodiments to yield other embodiments not expressly delineated as such.

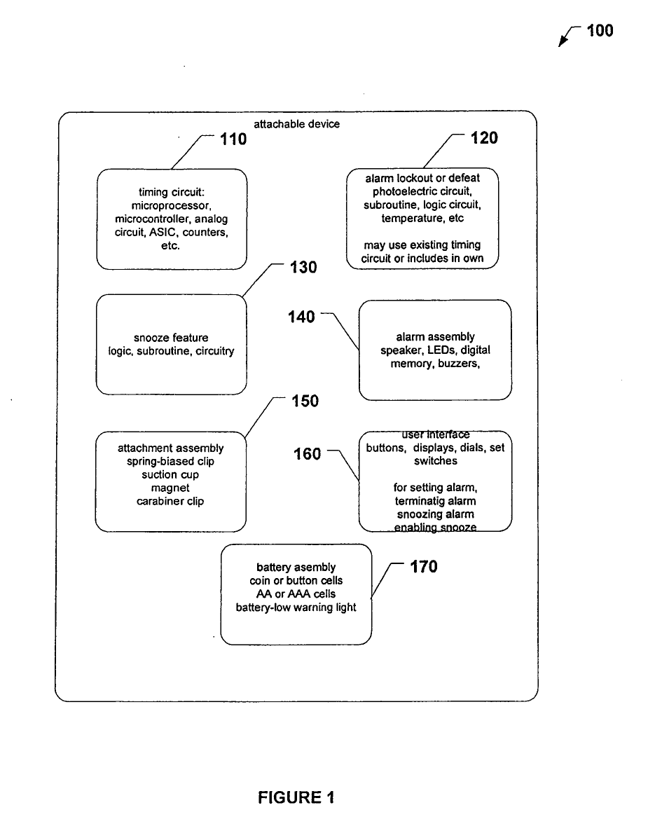

FIG. 1 shows an exemplary programmable timer 100. Programmable timer 100 includes a programmable timing circuit 110, an alarm lockout feature 120, a snooze feature 130, an alarm assembly 140, a user interface 150, a battery assembly 160, an attachment assembly 170.

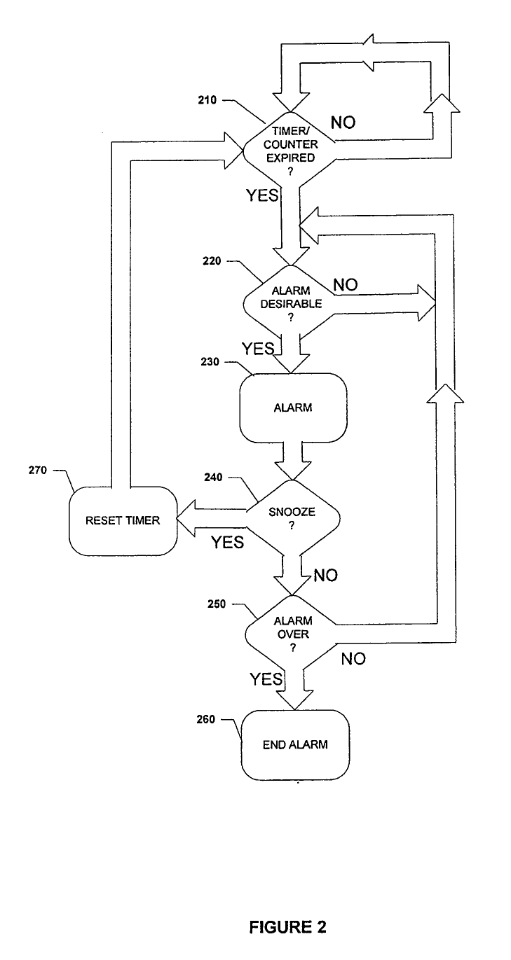

FIG. 2 shows an exemplary method of operating programmable timer 100 in the form of a flow chart 200. Flow chart 200 includes process blocks 210-270 which are arranged and described in a serial execution sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may implement the timer within a client-server architecture, such that some functions such as timing are implemented on the server side and other functions such as alarming or reminding are implemented in whole or in part on the client side, and vice versa. Moreover, still other embodiments implement the blocks as two or more interconnected hardware modules with related control and data signals communicated between and through the modules. Thus, this (and other exemplary process flows in this description) apply to software, hardware, and firmware implementations.

Block 210 entails determining whether a programmed time period has expired. In some embodiments, the time period is greater than or equal to 24 or 36 hours, and in other embodiments the timer period is less than 24 hours. If the time period has not expired execution loops back to block 210. If the time period has expired, execution continues at block 220.

Block 220 entails determining whether the current time is a desirable or appropriate alarm activation timer. In the exemplary embodiment, this entails determining whether a light sensor indicates that light is present or absent in a particular environment such as a refrigerator or cabinet. In the refrigerator or cabinet context, present of the light would indicate that the refrigerator is open and thus this would be an appropriate time to activate the alarm, whereas lack of light would indicate that the refrigerator is closed and that the alarm should not be activated. In some embodiments, the timer may have a black-out or lock-out period during which the alarm is not allowed to activate. For example, one may set that the alarm should not or should only activate during morning or during evening hours, using an AM or PM switch. If the current time is an undersirable alarm time, execution loops back to block 250. If the current time is a desirable alarm time, execution advances to block 230.

Block 230 entails activating an alarm. In the exemplary embodiment, this entails turning on a visible and/or audible alarm. In some embodiments, the audible portion of the alarm is a factory prerecorded audible message or a user recordable message. In some embodiments, the alarm may run for period of time such as 5, 10, or 15 seconds or minutes for pausing or shutting down.

Block 240 entails determining whether a snooze function has been activated. If the snooze function has been activated, for example, by a user pushing a snooze button, execution branches to block 250. Otherwise execution branches to block 260.

Block 250 entails resetting the timer for a snooze period. In some embodiments, duration of the snooze period is a function of the original timer period; however in other embodiments it is a fixed period independent of the original timer period. Also, in some embodiments, the snooze period is controlled by a separate timer element or function. From block 250 execution returns to block 210.

Block 260 entails determining whether to deactivate the alarm. In the exemplary embodiment, this entails determining whether the alarm has run for a specific period of timer or whether the alarm has been turned off by a user. If the determination is negative, execution returns to block 220. However, if the determination is positive, the alarm is terminated.

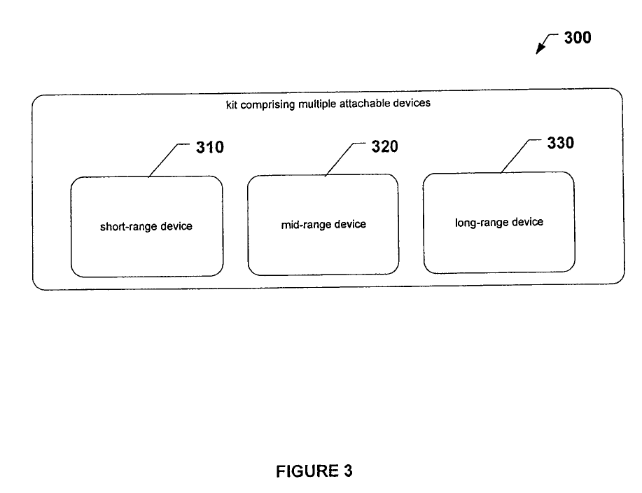

FIG. 3 shows an exemplary timer kit 300. Kit 300 includes a short-range timer 310, a mid-range timer 320, and a long-range timer 330. Some embodiments may include two or more of each of the short-, mid-, or long-range timers.

Various uses and/or alternative timer and reminder functionality that is or may be programmed into timer 100 are described below.

### Fridge Troll™ Alarm Device

Device mounted or positioned in refrigerator, e.g., on wall via magnet or suction cup or spring-loaded clip, Velcro. Device detects change from dark to light (caused typically by referigerator light) and activates alarm. Alarm could take any one or combination of the following: flashing lights, factory recorded audio message, user-recorded audio messge. Exemplary messges: Remember your Diet; Eat your Vegetables; You're Gorgeous; You're Gorgeous—Let's Keep it That Way; Oink-Oink; Moooooo; Celery is your best; Back again?

Some embodiments randomize the alarm so that it's doesn't become annoying; others activate the alarm every n-th time the refrigerator (or cabinet) is opened. n could be preset at the factory, for example, every 3, 5, or 7th time; or set by the user as desired using some type of switch, button, or dial, for example. Other embodiments may enable alarm when refrigerator is open, and trigger based on movement of particular food to encourage or discourage eating of same with appropriate message, again factory or user set.

### Left-over Minder Device (Food Spoilage Prevention)

User can set device to activate an alarm after a period of time, such as 1 hour, 3 hour, 1 day, 2 days, 1 week, etc. Alarm could take form of light and/or output of recorded audio message or other sound. Alarm will be locked out if the set time period expires while the device is a dark environment; device will then sound the alarm the next time the refrigerator (or cabinet); more generally next time it senses a dark-to-light transition. Some embodiments may refine this lockout feature to enable alarm to trip only during daylight waking hours or to trip with the audio muted or at lowered volume. (Some embodiments allow users to set volume.) This device includes a snooze feature, e.g., in the form of one or more buttons or switches, for example, that will reset the alarm to go off some time later. For example, some embodiments, the snooze feature is configured to set the alarm off again in one hour, in two hours, in one day, or in two days. Activation of the alarm after expiration of the snooze period would again be deferred to the next time the refrigerator or cabinet is opened, if expiration occurs while the device is in darkness. Some embodiments allow the user to control duration of the snooze period. For example, some devices will set the snooze period as a fraction of the period of the initial alarm time period. For example, if the initial alarm time period was set go off in 2 days, the snooze period could be automatically set to 1 day. Or, if the alarm period was 2 hours, the snooze period would be 1 hour. Other fractions could be used. A range of fixed snooze periods could also be offered for the user to select from. (This device could be used to remind folks to take medication)

### Bill Minder Device (Remind Users About Payment of Bills or Follow up Actions Need on Other Documents)

Works similar to left-over reminder. However, because of the range of times for various bill payment scenarios, I envision packaging sets of two or more timers and selling as a kit, perhaps a bill manager or financial coaching kit. Kit or device ensemble would in some embodiments, include three timers: one for short timeframes, e.g., up to a week; another for medium timeframes, e.g., up to a month; and another for long timeframes, e.g., up to a year;

### Executive Document Minder (Remind Folks to Sign or Review Hot Documents)

Works similar to left-over reminder, but in an office context. Secretary or paralegal, or other worker could leave a document for signature or review with another worker, with the minder device clipped on or otherwise temporarily bound or attached to the document (book, package, whatever). The document sender would set or select duration of the timer, and alarm would activate when timer expired. Alarm could be light, buzzer, and/or recorded message. Minder device includes snooze features, such as described above. Some embodiments would allow a user to lock out normal snooze mode. In this case, hitting the snooze button, would provided mute alarm or reschedule alarm for 10 seconds, 30 seconds, or minute. In some embodiments, the alarm would take on a different character during this time, emphasizing for example, the criticality that the document be dealt with. The recordable message feature would enable the device to also function as digital post-it note, with the recordable message limited in some embodiments to 1, 2, or 3 minutes. A bar graph or other visual indicator would be included in these or in other embodiments, to indicate how much recording time is remaining for the user who is recording and/or for the listener is listening. The indicator in some embodiments, would take the form of a series of LEDs with the LEDs illuminating or in some instances de-illuminating to indicate amount of recording time remaining or used.

The devices could be sold or given away by banks or credit card companies or with company logos as promotions. Such devices would be imprinted with or otherwise indicate company logos, slogans, etc.

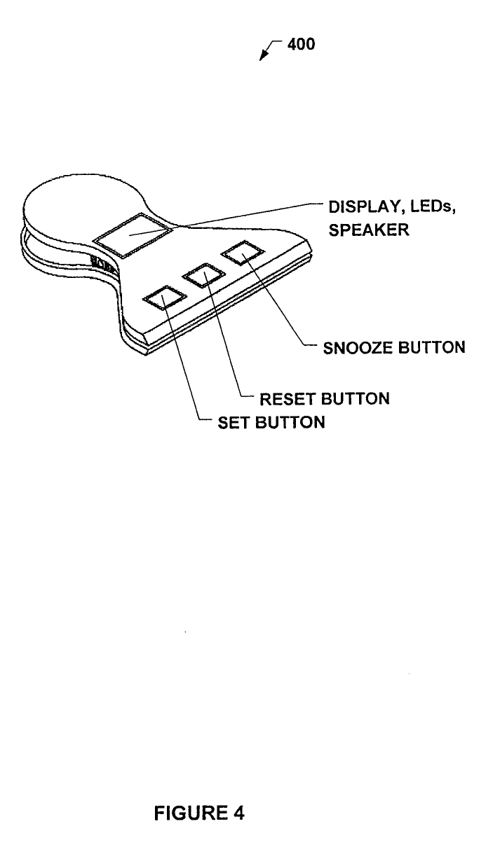

FIG. 4 shows an exemplary timer 400, which can include the functionality described above. However, the timers described herein may have the same or entirely different form factors, for example as illustrated in the provisional application incorporated by reference. In one embodiment, the device resemble a spring-biased clip or clothespin formed from metal wood, or plastic. One or more of the following timers can be modified according to teachings in this applications. Exemplary flow chart. Light-on decision block is one example of a more general decision block for determining whether the current “time” is a “good” or desirable time for activating the alarm. Reset timer block can reset timer based on one or more factory settings, based on previously set alarm, or based on particularly user snooze selection. Alarm can include visible and/or audible aspects, such recorded audio message, flashing light, or beeping or buzzing.

LEDs could be used to indicate duration of alarm or snooze. Eg. One illuminated LED might indicate 10 minutes, 2 LEDs might indicate 30 minutes, and 3 LEDs might indicate 1 hour. This could be for the snooze mode or original period of alarm.

Some embodiments set duration of alarm or of snooze period by counting number of pushes of an alarm set or snooze button. The button could be held down for a set period of time to enter the alarm set mode during which the user might increment (or decrement) alarm time from some start value. An LED, in some instances, would flash to indicate activation of the alarm set mode. In one embodiment, one push indicates 10 minutes, for example; two pushes 30 minutes, and three pushes 2 hours, with LEDs (and/or another indicator, such as an audio message or alphanumeric display) indicating the duration to the user. Another button could be used to start the alarm after the set mode is exited.

After alarm sounds, the alarm set button, in the exemplary embodiment, functions as the snooze button, with the number of pushes setting duration of the snooze period. In some embodiments, only a single snooze duration would be possible with the push of the button. (Other additional snooze pushes could reset the snooze period or be ignored entirely.) The snooze duration, in the exemplary embodiment, is based on the previous alarm setting or set independently of that setting. Holding the alarm set button during an alarm terminates the alarm.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

1-6. (canceled)

7. Document management means for removable attachment to a paper document and for reminding a user to take action in relation to the paper, the document management means comprising:
a manually programmable countdown timer circuit;
alarm means, coupled to the timer circuit, for indicating expiration of a first predetermined period of time; and
snooze means for stopping the alarm means and for resetting the timer circuit after expiration of the predetermined period of time to a second predetermined period of time less than the first period of time.

8. The document management means of claim 7, further comprising:
means, responsive to ambient light conditions, for deferring operation of the alarm means after expiration of the first or second predetermined period of time to a later time.

9. The document management means of claim 7, wherein the alarm means includes means for digitally recording a message and playing back the recorded message.

10. The document management means for claim 7, including a spring clip for clipping the paper document.

11. The document management means for claim 7, wherein the alarm means outputs a first alarm signal in response to expiration of the first time period and a second alarm signal, different than the first alarm signal, in response to expiration of the second time period.

12. The document management means for claim 7, wherein duration of the second time period is a function of the first time period.

13. The document management means for claim 7, wherein duration of the second time period is manually programmable via a push button.
